(19) United States
(12) Patent Application Publication
(10) Pub. No.: US 2018/0167498 A1
(43) Pub. Date: Jun. 14, 2018

(54) ELECTRONIC DEVICE STAND

(71) Applicant: Robert A. DRAKOS, Jasper (CA)

(72) Inventor: Robert A. DRAKOS, Jasper (CA)

(21) Appl. No.: 15/658,229

(22) Filed: Jul. 24, 2017

Related U.S. Application Data
(63) Continuation-in-part of application No. 14/815,695, filed on Jul. 31, 2015.
(60) Provisional application No. 62/031,466, filed on Jul. 31, 2014.
(60) Provisional application No. 62/182,345, filed on Jun. 19, 2015.
(60) Provisional application No. 62/199,627, filed on Jul. 31, 2015.
(60) Provisional application No. 62/265,935, filed on Dec. 10, 2015.

(51) Int. Cl. H04M 1/04; F16M 11/06; G06F 1/16

(52) U.S. Cl. CPC H04M 1/04; G06F 1/1632; F16M 11/06

(57) ABSTRACT

A stand for a personal electronic device includes a base portion collapsably coupled to a further supporting portion and the personal electronic device. The stand is readily adjusted into various arrangements to support the personal electronic device in respective configurations for viewing and other uses.

### CROSS-REFERENCE TO RELATED APPLICATIONS

The present application is a continuation-in-part of U.S. utility patent application Ser. No. 14/815,695 filed on Jul. 31, 2015 which in turn claims the benefit of U.S. provisional patent application Nos. 62/031,466 filed Jul. 31, 2014; 62/182,345 filed Jun. 19, 2015; and 62/199,627 filed Jul. 31, 2015; the present application claims the benefit of U.S. provisional patent application No. 62/265,935 filed on Jul. 22, 2016, the disclosures of all the foregoing are herewith incorporated by reference into the present application in their entireties.

### FIELD OF THE INVENTION

The present invention relates to electronic apparatus and more particularly to electronic apparatus with support features.

### SUMMARY

In the space of a few short years, personal electronic devices have gone from rare to ubiquitous. During the same time interval the capabilities of such devices have increased at a fantastic rate. Whereas the earliest models provided only limited voice communications, recent devices present a huge array of intrinsic and importable functions, including virtually all those functions previously available in desktop personal computers as well as photographic and video capture features, voice recording, global positioning/location identification, tracking and mapping. This growth and functionality corresponds to the development of tremendously better hardware and a huge expansion in available software.

Notwithstanding these great advances, there remain limitations on the use of personal electronic devices. Such limitations are illustrated, for example, by the recent emergence of “selfie sticks” which allow a user to hold an electronic device at a distance while taking a self portrait photograph. Clearly there is an understanding that self portraiture is desirable and is not readily accomplished in a way that produces high-quality results. Nevertheless, and despite the evident efforts by some to overcome the limitations of current devices, existing approaches to solving these and other problems of personal electronic devices remain far from optimal.

Having examined and understood a range of previously available devices, the inventor of the present invention has developed a new and important understanding of the problems associated with the prior art and, out of this novel understanding, has developed new and useful solutions and improved devices, including solutions and devices yielding surprising and beneficial results.

The invention encompassing these new and useful solutions and improved devices is described below in its various aspects, with reference to several exemplary embodiments including a preferred embodiment.

The following description is provided to enable any person skilled in the art to make and use the disclosed inventions and sets forth the best modes presently contemplated by the inventor of carrying out his inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art will appreciate that the figures taken together reflect various embodiments exemplifying the invention.

Correspondingly, reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in schematic anterior perspective view, a device stand prepared according to principles of the invention and arranged in a landscape configuration;

FIG. 2A shows, in schematic posterior perspective view, a device stand prepared according to principles of the invention including a universal mount element;

FIG. 2B shows, in schematic posterior perspective view, a device stand prepared according to principles of the invention including a case element;

FIG. 3A shows, in schematic perspective view, a portion of a device stand prepared according to principles of the invention including a case element;

FIG. 3B shows, in schematic perspective view, a portion of a device stand prepared according to principles of the invention including a universal mount element;

FIG. 4A shows, in schematic perspective view, a portion of a device stand prepared according to principles of the invention including a pin element;

FIG. 4B shows, in schematic elevation, a portion of a device stand prepared according to principles of the invention including a pin element;

FIG. 5 shows, in schematic perspective view, a device stand prepared according to principles of the invention and arranged in a compact folded configuration; and

FIG. 6 shows, in schematic perspective view, a device stand prepared according to principles of the invention and arranged in a wall-mount configuration.

FIG. 7A shows, in schematic perspective view, a portion of a device stand prepared according to principles of the invention.

FIG. 7B shows, in schematic cross-section view, a portion of a device stand prepared according to principles of the invention.

FIG. 7C shows, in schematic perspective view, a portion of a device stand prepared according to principles of the invention.

FIG. 7D shows, in schematic cross-section view, a device stand prepared according to principles of the invention.

FIG. 8A shows, in side view, a device stand prepared according to principles of the invention.

FIG. 8B shows, in side view view, a device stand prepared according to principles of the invention.

FIG. 9 shows, in cutaway perspective view, a device stand prepared according to principles of the invention.

FIG. 10 shows, in schematic perspective view, a portion of a device stand prepared according to principles of the invention.

FIG. 11 shows, in cutaway perspective view, a further device stand prepared according to principles of the invention.

### DETAILED DESCRIPTION

The following description is provided to enable any person skilled in the art to make and use the disclosed inventions and sets forth the best modes presently contemplated by the inventor of carrying out his inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed.

The present invention relates to a stand that allows users to easily place their phone or electronic device at a variety of angles, similar to a tripod but with improved performance. It also allows the device to be rotated from a portrait to a landscape viewing position. The stand collapses into a single layer which allows the design to be as thin as possible. The stand can be attached to either a universal mount which fits most smartphones manufactured in the past five years, or a case which fits the iPhone 6 and 6 Plus models. The case protects the device from damage if dropped. The stand helps individuals take pictures and interact with their device when using handsfree applications. It also amplifies the sound coming out of the device, allows users to charge their smartphones on the wall by fitting over the iPhone square style charger, and is stable enough to be mounted to a dash of an automobile with a microsuction mat and stand in place.

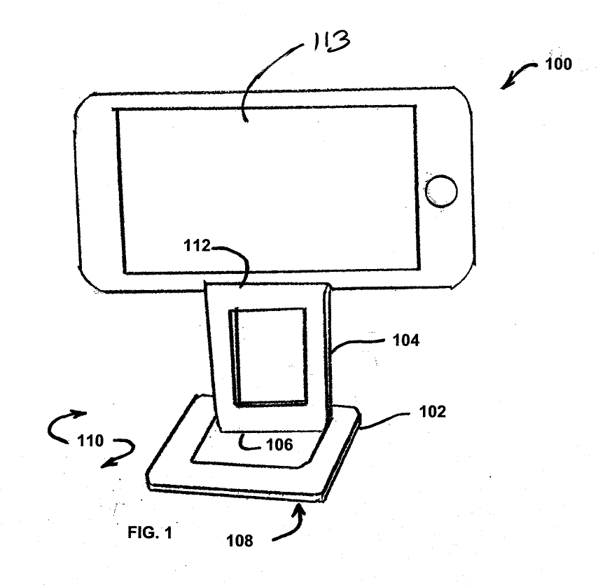

FIG. 1 shows, in schematic perspective anterior view, a device stand 100 prepared according to principles of the invention. The device stand 100 is shown coupled to and supporting a “smart phone” style cellular telephone 113. Any reader will appreciate that such a telephone 113 is merely exemplary of a variety of electronic devices with which the illustrated stand 100, or another of similar characteristics, may be beneficially employed.

As illustrated, the device stand 100 includes a base element 102 and an arm element 104 that is pivotally coupled to the base element 102 at a distal end 106 thereof. A proximal end 112 of the arm element is pivotally coupled to a support portion (not shown) as will be further discussed below. It should be noted that the modifiers “proximal” and “distal” are taken with respect to the electronic device supported by the device stand 100 in the illustrated configuration. One of skill in the art will appreciate that these relationships will change in accordance with changes made by a user, or others, in the device stand's configuration at a particular time.

The base element 102 includes a distal surface region 108 configured for placement adjacent to, and supported by, any appropriate upwardly facing surface region 110. It should be noted that the upwardly facing surface region 110 may be substantially level, or may be disposed at an oblique plane angle with respect to a level plane. The pivotal couplings at the distal 106 and proximal 112 ends of the arm element allow an orientation of the cell phone 113 or other device to be conveniently arranged, irrespective of the orientation with respect to horizontal of the upwardly facing surface 110.

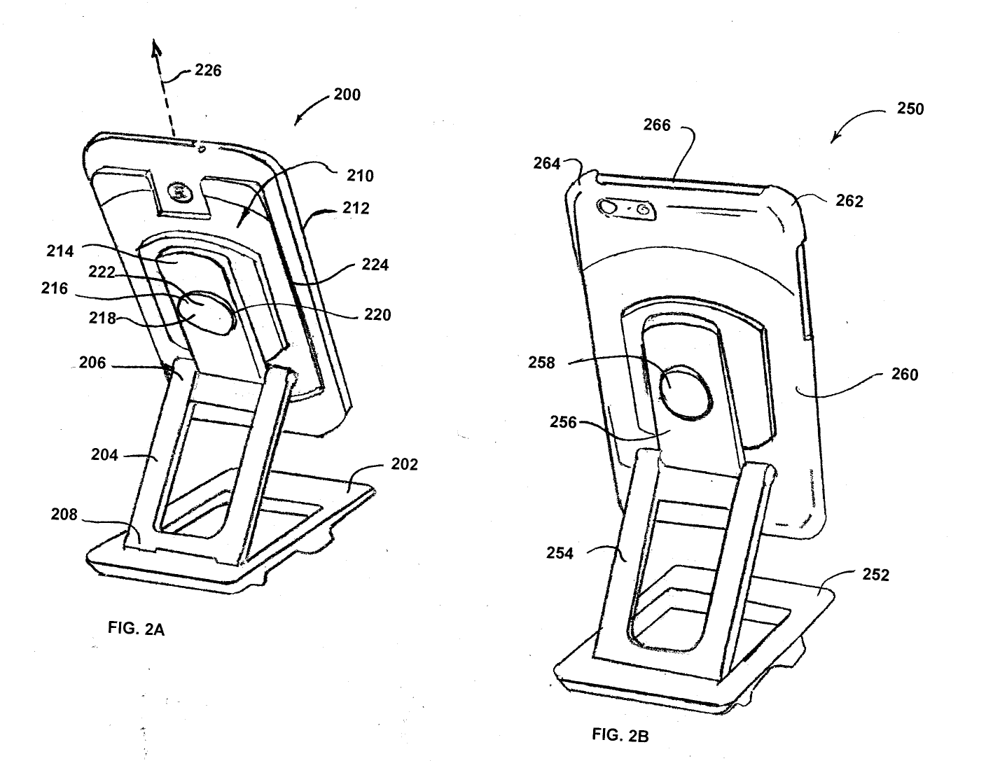

FIG. 2A shows, in schematic perspective posterior view, a further aspect of a device stand 200 prepared according to principles of the invention. It should be noted that certain embodiments of the device stand 200 will have an anterior aspect similar to that of device stand 100 shown in FIG. 1.

Device stand 200 includes a base element 202 and an arm element 204. Arm element 204 has a proximal end 206 and a distal end 208. Proximal end 206 is pivotally coupled to a supporting assembly 210. A personal electronic device 212 (here a “smart phone” style cellular telephone) is coupled to the supporting assembly and supported by the device stand 200.

The supporting assembly 210 includes a tongue element 214 that is pivotally coupled at one end thereof to the arm element 204. A pin element 216 is disposed through a medially located through hole defined in the tongue element 214. A portion of the pin element 216 adjacent a proximal end 218 of the pin element 216 serves as a retainer portion 222 and exhibits a circumferential edge 220 that is larger in diameter than the through hole.

A distal portion (not shown) of the pin element is substantially fixedly coupled to a corresponding portion of a universal mount element 224. In various aspects and embodiments of the invention, the universal mount element 224 is substantially fixedly coupled to a posterior surface of the personal electronic device 212 such that the personal electronic device and the universal mount element are disposed in substantially fixed spatial relation to one another. This substantially fixed coupling between the personal electronic device 212 and the universal mount element 224 will be achieved, in various embodiments respectively, by the application of a chemical adhesive; a mechanical fastener such as, for example and without limitation, a screw, a nail, a rivet, a nut and bolt combination; by the application of a thermal weld between a portion of a case of the personal electronic device and the universal mount element; an ultrasonic weld likewise disposed; a laser weld likewise disposed; an electric arc weld, where conductive materials are employed, or any other appropriate fastening method known, or that becomes known, in the art.

In the illustrated embodiment, the pin element 216 includes a circumferential surface having a generally circular cylindrical aspect corresponding to a similar circular cylindrical aspect of the through hole defined in the tongue element 214. Consequently, the pin element 216 is capable of being rotated with respect to the tongue element 214. Inasmuch as the pin element 216 is substantially fixedly coupled to the universal mount element 224, rotation of the universal mount element 224 causes the indicated rotation of the pin element with respect to the tongue element, and therefore with respect to the arm element and base element.

In the illustrated configuration, a longitudinal axis 226 of the cellular telephone 212 is arranged in a generally vertical orientation. For purposes of this disclosure, and consistent with typical usage in the art, this orientation is referred to as “portrait” orientation. In light of the foregoing disclosure, however, one of skill in the art will appreciate that the personal electronic device 212 can readily be rotated, about a longitudinal axis of the pin element 216, into a configuration in which the longitudinal axis 226 of the personal electronic device is disposed in a generally horizontal orientation. This orientation, in which the longitudinal axis 226 of the personal electronic is disposed generally horizontally, is referred to as “landscape” orientation for purposes of this disclosure (and as a matter of general usage).

Referring again to FIG. 1 one sees an example of a stand and personal electronic device configured in such a landscape orientation. It will be appreciated by one of skill in the art that, where desirable to a user, the personal electronic device may be rotated through 360° into any intermediate angular orientation between portrait orientation and landscape orientation; inverted portrait orientation and inverted landscape orientation, inclusive. Thus, in appropriate circumstances, longitudinal axis 226 will be aligned at any one of a wide variety of oblique angles with respect to vertical.

FIG. 2B illustrates a further aspect and configuration of a device stand 250 prepared according to principles of the invention. Like device stand 200 device stand 250 includes a base element 252, an arm element 254, a tongue element 256 and a pin element 258. Device stand 250 differs from device stand 200 in that it includes a case element 260 rather than a universal mount element 224. The case element 260 is substantially fixedly coupled to an adjacent end region of the pin element 258, and arranged with respect to the tongue element 256, arm element 254 and base element 252 so as to allow rotation of the case element 260 about a longitudinal axis of the pin element 258. In contrast to the universal mount element 216, the case element 260 includes curved regions, e.g. 262, 264 configured and adapted to grasp a corresponding personal electronic device 266 at respective surface regions thereof so as to hold the personal electronic device 266 in substantially fixed spatial relation to the case element 260.

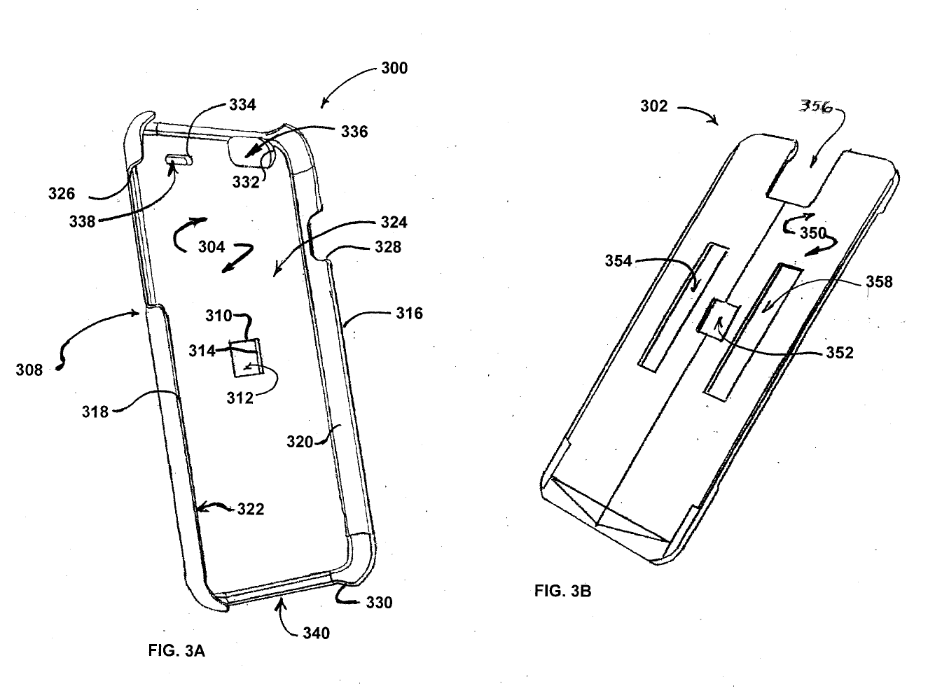

An exemplary case element 300 is shown in further detail in FIG. 3A and an exemplary universal mount element 302 is shown in further detail in FIG. 3B. Case element 300 exhibits a first interior region 304. In the illustrated embodiment, interior surface region 304 is shown as being generally planar. As such it will be well adapted for placement in proximity to a personal electronic device having a similarly planar back surface region.

One of skill in the art will appreciate that in certain specialized applications, a personal electronic device having a back surface region of substantially any other configuration will be accommodated by a case element 300 with a correspondingly arranged interior surface region 304.

Although not visible, one of skill in the art will appreciate that an exterior surface region 308 is disposed in substantially parallel spaced relation to interior surface region 304. An interior edge 310 of surface region 304 defines an aperture 312, and through-hole, to an aligned corresponding aperture 314 of surface region 308.

In the illustrated embodiment, interior edge 310 is presented as having a generally square aspect. In light of the further description below, one of skill in the art will appreciate that the square aspect will be well adapted to receive a corresponding generally square feature of a pin element, e.g., 258. It will likewise be appreciated, however, that while the illustrated aperture 310 is square, any of a wide variety of other shapes will be beneficially employed in corresponding embodiments of the invention along with correspondingly shaped features of a respective pin element.

In many of these embodiments, as in the one illustrated here, the shape of the aperture will be adapted to prevent rotation of the pin element around its longitudinal axis with respect to the case element 300. Thus, for example, in many embodiments, the aperture will have a polygonal aspect, an elliptical aspect, a stellate aspect, or any other useful non-circular aspect including, for example an aperture with a key-style or spline-style characteristic. The foregoing notwithstanding, in certain other beneficial embodiments of the invention, the aperture will exhibit a substantially circular aspect, allowing rotation of the case element 300 with respect to the pin element.

Case element 300 also includes side portions, e.g. 316, 318 with respective interior surface regions 320, 322. In the illustrated embodiment, interior surface regions 320 and 322 are disposed in a generally perpendicular orientation with respect to interior surface region 304. As such, interior surface region 304, along with interior surface regions 320, 322 define a recess 324 adapted to receive a personal electronic device therewithin.

Further, in certain embodiments, as illustrated, the interior surface regions, e.g. 320, 322 will exhibit a generally concave aspect. In cases where the personal electronic device includes sides having a similar convex aspect, the interior surface regions, e.g. 320, 322 will be well adapted to couple to and grasp those sides of the personal electronic device, securing the personal electronic device in substantially fixed spatial relation to the case element 300.

Where desirable, the case element 300 will include a material having a modulus of elasticity appropriate to allow insertion of the personal electronic device into the recess 324 by an elastic flexure of the case including interior surface regions 304, 320 and 322. Restorative forces of the material will, thereafter, tend to urge the interior surface regions 320, 322 back around the corresponding sides of the personal electronic device, again maintaining the device and the case element in close association with one another.

Various materials will exhibit a desirable modulus of elasticity, as well as other desirable characteristics, including polymer materials such as thermoplastics, thermosets and a variety of elastomeric materials, metallic materials including metals and metallic alloys such as, for example, shape memory alloys, synthetic and non-synthetic materials including, for example, wood, leather, bamboo, paper, and combinations of one or more of the foregoing.

Suitable polymers include polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used. For example, a blend of polycarbonate and ABS (Acrylonitrile Butadiene Styrene) may be used.

Suitable metal or metallic alloys may include stainless steel; aluminum; an alloy such as Ni/Ti alloy; any amorphous metals including those available from Liquid Metal, Inc. or similar ones, such as those described in U.S. Pat. No. 6,682,611, and U.S. Patent Application No. 2004/0121283, the entire contents of which are incorporated herein by reference.

As further illustrated in FIG. 3A a case element 300 will include certain additional edge regions, e.g. 326, 328, 330, 332 and 334 defining respective apertures and/or through-holes in interior surface region 304 and, e.g 320, 322. These apertures, e.g., 336, 338, 340 will align with respective features of a personal electronic device. Thus, for example, aperture 336 will, when in use, align with a camera lens of certain smart phone style cellular telephones. Aperture 338, when in use, will align with a range sensor of one or more smart phone style cellular telephones. Aperture 340 when in use will align with a charging port of one or more smart phone style cellular telephones.

It will be appreciated that certain embodiments of the case element 300 will include apertures and other features appropriate for use with a wide variety of personal electronic devices. In other cases, a case element 300 will include features highly specific to a particular personal electronic device, such that the case element 300 will be specifically selected and applied for that personal electronic device either as an individual element or as part of a customized assembly.

FIG. 3B shows, in further detail, a universal mount element 302. Like the case element 300, the universal mount element 302 includes a surface region configured and adapted to be placed in close proximity to a particular surface of a personal electronic device so as to support that device and maintain it in substantially fixed relation to the universal mount element 302. As noted above, the substantially fixed relationship between the universal mount 302 and the personal electronic device will be effected in any technically appropriate manner by use of an adhesive, mechanical fastener, or other fixing means.

Like the case element 300, the universal mount element 302 includes an aperture 352 adapted to receive a portion of a pin element therethrough. Again, the configuration of the aperture will match a similar configuration of the pin element so as to, in certain embodiments, ensure a generally fixed spatial relationship between the pin element and the universal mount element 302, as well as the personal electronic device.

One of skill in the art will appreciate that in certain embodiments, however, this aperture 352 will be omitted and the pin element will be substantially fixedly coupled to the universal mount by, for example, a welded bond, or integrally formed with the universal mount. In such an embodiment, the pin element will include a further retaining feature that allows a rotational coupling to a tongue element as described above. Naturally, the same approach will be beneficially employed in certain embodiments that include a case element, e.g. 300, rather than a universal mount element 302.

Also, as illustrated, various embodiments of the universal mount element 302 will include appropriate apertures, e.g., 354, 356, 358 corresponding to respective features of one or more personal electronic devices. That is apertures will be provided that are appropriate to a particular device, or adaptable for use with any one of a selection of devices. Furthermore, in certain embodiments, a case element 300 or universal mount element 302 will include apertures that are customized for a particular device by a particular manufacturing step, where the manufacturing step is determined according to a custom order of an individual. In still other embodiments, a case element 300 or universal mount element 302 will include apertures that are customized for particular device by an end-user who removes a pre-formed knockout by breaking, for example, a perforated reduced or scribed frangible region of the corresponding case element or universal mount element. In still other embodiments, a case element 300 or universal element 302 will be delivered to an end-user with a specialized or generalized tool arrangement configured for customization of the case element or universal element.

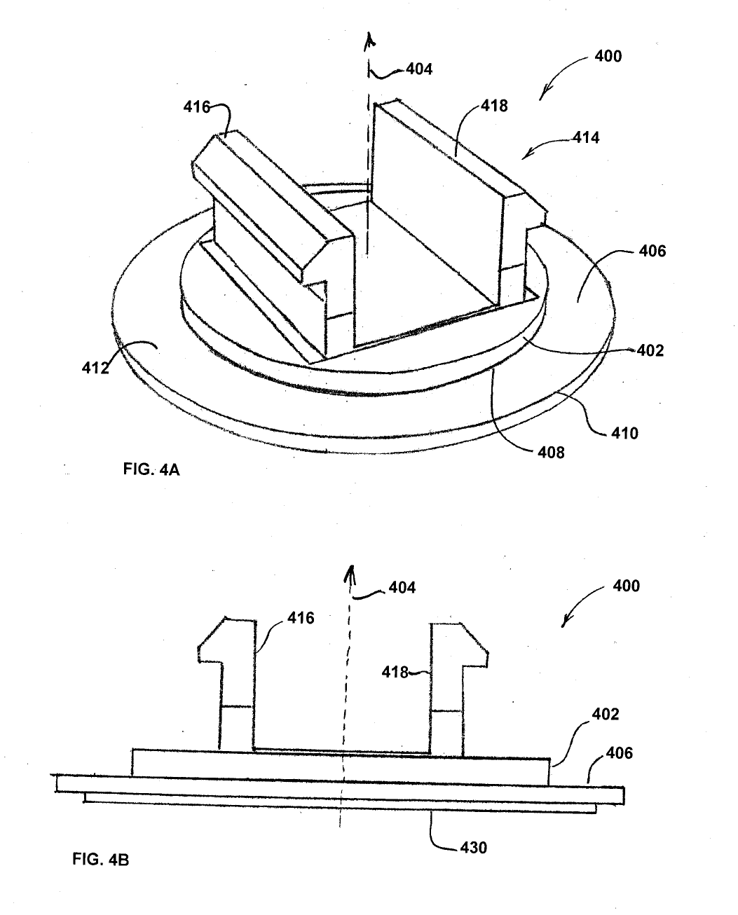

FIG. 4A shows, in schematic perspective view, an exemplary pin element 400 prepared according to principles of the invention. The pin element 400 includes an exemplary external surface region 402 having a generally circularly symmetric aspect. Surface region 402 is a bearing surface region and is adapted to be disposed in close proximity to a corresponding internal surface region of a tongue element (e.g., tongue element 256 as shown in FIG. 2B). These surface regions allow rotation of the tongue element with respect to the pin element 400 about a longitudinal axis 404 of the pin element 400.

A further bearing surface region 406 exhibits, in the illustrated embodiment, a generally annular characteristic such that the bearing surface region 406 is disposed between and internal edge 408 and an external edge 410. In the illustrated embodiment, the bearing surface region 406 is shown as being substantially planar. One of skill in the art will appreciate, however, that a variety of other configurations including various complex curves will be beneficially employed in corresponding embodiments.

Surface region 408 forms constitutes part of an expanded portion, or head 412, of the pin element 400. The head 412 serves to retain the pin element 400 (and consequently a case element or universal mount element) in proximity to a tongue element while allowing rotation of the case element or universal mount element with respect to the tongue element. In the illustrated embodiment, the head 412 is integrally formed with the balance of the pin element 400. In other embodiments, however, the head element will be removably coupled to the balance of the pin element by, for example, a threaded coupling or any other appropriate coupling. In still other embodiments, the head 412 will be substantially permanently fixed to the balance of the pin element 400 by any appropriate manufacturing process including, for example and without limitation, thermal bonding, chemical adhesive bonding, laser welding, ultrasonic welding, etc.

In the illustrated embodiment, the pin element 400 further includes a barbed coupling portion 414 including first 416 and second 418 barbed members. Barbed members 416 and 418 will be appropriately configured and formed of appropriate materials so as to allow assembly of the pin element 400 with a case element or universal element. One of skill in the art, in light of the present description, will immediately understand that the barbed coupling portion will be advantageously inserted through, for example, aperture 312 or aperture 352 of case element 300 or universal mount 302 respectively.

Again, it should be understood that barbed coupling portion 414 represents only one of a wide variety of means and mechanisms that will be employed in various corresponding embodiments of the invention to provide an appropriate coupling between the above-described elements and a desirable rotation of the case element, e.g., 300 or universal mount element, e.g., 302 with respect to a tongue element, e.g., 256.

FIG. 4B shows, in cross-sectional elevation, a further aspect of pin element 400. In this view, one readily sees the exemplary configuration of barbed members 416 and 418, as well as the exemplary relationship of bearing surfaces 402 and 406 to longitudinal axis 404. Also shown is an optional raised surface region 430. In certain embodiments of the invention, the raised surface region 430 will be beneficially employed to support and display a trademark or other indicia either formed in a surface portion of the raised surface region, printed thereon or applied as a label thereto.

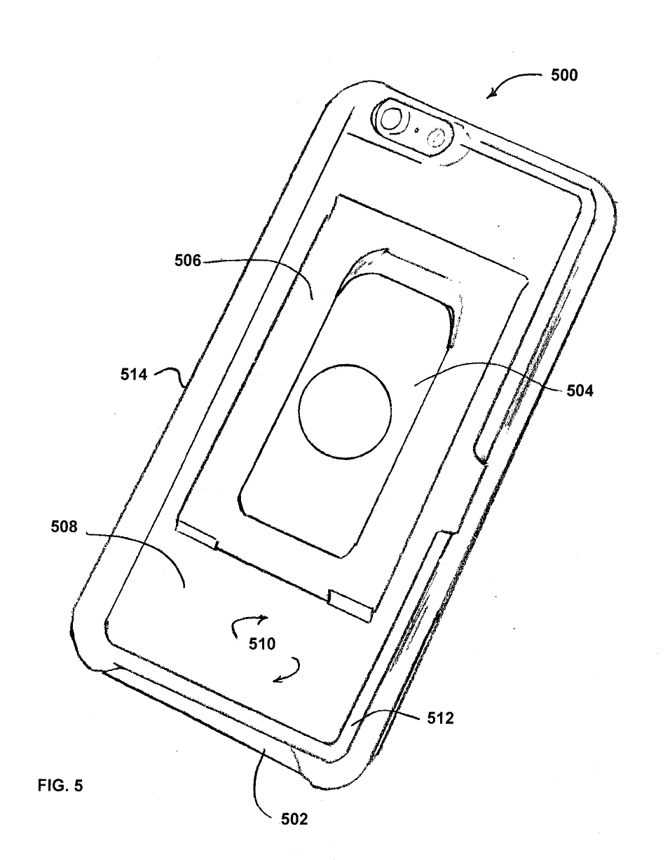

FIG. 5 shows a stand 500 prepared according to principles of the invention, in conjunction with a corresponding personal electronic device 502, and displayed in a folded configuration. One of skill in the art, having reviewed the foregoing disclosure, will appreciate that the pivotal relationship between the base element 200, arm element 204, and tongue element 214 described above with respect to, e.g., stand 200 (FIG. 2A), will allow the stand 500 to be folded into the configuration of FIG. 5. In this compact configuration, the entire assembly of stand 500 and personal electronic device 502 will be readily stored and/or transported within a spatial envelope hardly larger than the personal electronic device itself. In this folded configuration, the tongue element 504 fits compactly within a corresponding aperture of the arm element 506 which, in turn, fits within a corresponding aperture of the base element 508.

In the configuration of FIG. 5, a “lower” surface region 510 of the base element 508, corresponding to, e.g., lower surface region 108 of FIG. 1, is visible. An “upper” surface region of the base element 508 is disposed adjacent to an external surface region 512 of the support element (here shown as a case element 514) of the stand 500.

One of skill in the art will appreciate that the above-described pivotal connection between the base element, arm element, and tongue element will be made in a variety of ways appropriate to particular embodiments of the invention. In one embodiment, for example, respective roll pins will be inserted into through-holes provided, respectively, at the distal and proximal ends of the arm element and into corresponding apertures of the base element and tongue element, so as to provide the described pivotal motion. In certain embodiments, the roll pins will include a spring pin having a radial elasticity appropriate to ensure a consistent coefficient of static friction with respect to the various elements. In still further embodiments of the invention, the spring pin will include a multi-layer spring pin having a continuous spiral cross-sectional aspect. Consequently, the stand can be reliably and repeatedly placed into any desired configuration including open and closed configurations.

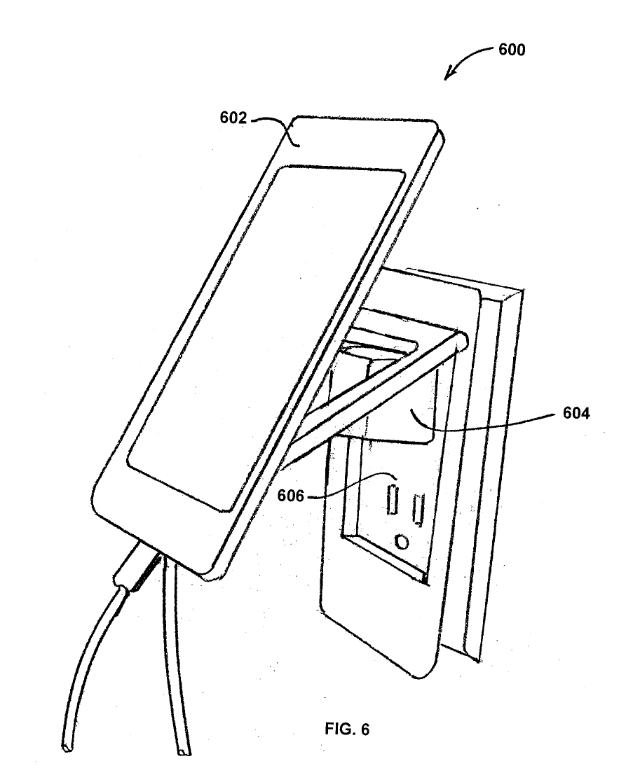

FIG. 6 shows, in schematic perspective view, an exemplary stand 600 prepared according to principles of the invention, along with an associated personal electronic device 602, in a wall-mount configuration. As illustrated, the wall-mount configuration allows the stand 600 to be supported by, for example, a charger 604 of the personal electronic device 602. The charger, in turn is coupled to, and supported by, a conventional electrical wall receptacle 606. Such an arrangement will be beneficial both because it allows, in certain circumstances, convenient viewing of the personal electronic device by a user while charging, and because it avoids the need to leave the personal electronic device propped against the wall, disposed on a floor, or suspended by its charging cable, while charging.

In various aspects and embodiments, the stand of the invention allows a phone or other electronic device to stand at any angle on its own. It provides for the ability of the electronic device to be presented in a landscape orientation, portrait orientation, or any intermediate orientation according to requirements of a user and according to particular circumstances.

In certain aspects and embodiments, a stand according to principles of the invention will include features that constitute an audio impedance transformer which increases the efficiency of sound transfer and results in an apparent application of sound produced by a speaker or other transducer of the personal electronic device. In still other embodiments, an active device such as an application device is coupled to or integrally formed with the stand to provide active sound amplification.

In certain aspects and embodiments, a stand according to principles of the invention includes a feature adapted to couple the stand to a wall-plug mounted charging device so as to support the personal electronic device adjacent to the charging device.

In still further aspects and embodiments of the invention a stand includes features adapted to couple a base of the stand to an interior surface region of an automobile or other vehicle, a desk or other item of furniture, a wall of any room, floor, ceiling, or any other surface region where such coupling is desirable.

Among other advantages, the use of a device stand prepared according to principles of the invention will improve the facility of a user in, for example and without limitation, watching and taking video; watching and taking pictures; browsing the web and application; using Skype, FaceTime and other videoconferencing applications; using a flashlight application when in need of both hands (for example when using the personal electronic device as a lantern or desk lamp) while, for example, working on a car, playing music (where the lantern serves to illuminate sheet music and/or lyrics) and reading in the dark or in low light.

Still further advantages and benefits of using the stand include those experienced by a user when using the stand in conjunction with a personal electronic device for wall charging, where it is possible to place a phone or other device on a charger so that it is supported above an adjacent surface region of a floor while charging; mounting a personal device in a car, or other vehicle, for use as a global positioning system display, for playing music, taking calls, viewing text, or other hands-free uses appropriate to such vehicular applications. In certain embodiments, a microsuction mat is provided, either as a discrete element, or as an integrated feature of a base element, to ensure adequate coupling between a lower surface region of the base element and a corresponding upper surface region of whatever supporting surfaces appropriate to the particular circumstances.

In other desirable aspects, and in corresponding embodiments, the base element amplifies sound for playing music, watching video etc, when the device is placed over the amplification grove. The amplification groove works as an audio impedance transformer to improve the coupling between an audio transducer of the personal electronic device and the surrounding ambient atmosphere.

Ergonomic benefits of the device include the ability to support the device's weight on two fingers instead of just the individual's pinky finger when holding the device with one hand (reduces “iPhone pinky”; pinky being sore from the weight of the phone for long periods of time).

One of skill in the art will appreciate that the case element, when coupled about a corresponding personal electronic device, adds protection to the sides and front of the device in the event that the personal electronic device is dropped. In one embodiment, the case extends approximately 1 mm above the screen of the phone.

Other beneficial aspects, features and embodiments of a stand prepared according to embodiments of the invention include:
1. The stand adds protection to the back of the device in the event that the device is dropped
2. A slide-in Wallet and front flap
3. A slide-in Jogging arm band
4. An inner rubber lining for increased drop protection
5. A belt clip attachment

One of skill in the art will understand that many combinations will readily be derived from the foregoing description including:
1. Universal mount with a stand
2. Case with a stand
3. Just the stand in a UNIVERSAL SIZE which fits most smartphones manufactured in the past five years that feature a flat back (to be attached with two way tape to the smartphone)
4. The stand in a UNIVERSAL SIZE coupled with a case that holds the mobile device (different cases will be manufactured to hold different smartphones, however, the stand will remain the same)
5. A TABLET SIZE stand which fits most tablets manufactured in the past five years that feature a flat back (to be attached with two way tape to the tablet)
6. The stand in a TABLET SIZE couples with a case that holds the tablet device (different cases will be manufactured to hold different tablets, however, the stand will remain the same)

As noted above, one efficient axle type to be used in the stand is a coil pin. The design of this pin allows for it to contract into itself in the event that the case is dropped, reducing damage to the hole in which it is housed and absorbing part of the impact from the drop. In addition it provides added friction in the opposite direction to that in which it it rolled allowing the case to be easily opened which providing increased friction for it to be pressed closed, this is most important for a car application in the event that the automobile drives over a pothole.

An exemplary method of building the stand will include the steps of:
1. Aligning the holes for the coil pins in the “ARM” with the holes for the coil pins in the “Base”.
2. Ensuring the “ARM” and the “BASE” are in the upright position.
3. Aligning a coil pin in parallel with the hole on the left side of the “BASE” and pressing the coil pin in with a hand clamp
4. Repeating for the right side coil pin and hole
5. Setting the “TOUNGUE” in the center space of the “ARM”
6. Ensuring both are in the upright position.
7. Opening the stand so it is in the “WALL MOUNT” position
8. Aligning a coil pin in parallel with the hole on the left side of the “BASE” and pressing the coil pin in with a hand clamp
9. Repeating for the right side coil pin and hole
10. Setting the Stand in the “CLOSED” position
11. Positioning the square “TONGUE” hole over the square “UNIVERSAL MOUNT” hole ensuring both parts are in the upright position
12. Turning both parts over as one object
13. Pressing the “PIN” through the “TOUNGUE” until it snaps into the “UNIVERSAL MOUNT”
14. Applying two-way tape in the parallel grooves of the “UNIVERSAL MOUNT”

An exemplary method of building the case will include the steps of:
1. Aligning the holes for the coil pins in the “ARM” with the holes for the coil pins in the “Base”. Ensure the “ARM” and the “BASE” are in the upright position.
2. Aligning a coil pin in parallel with the hole on the left side of the “BASE” and pressing the coil pin in with a hand clamp
3. Repeating for the right side coil pin and hole
4. Setting the “TOUNGUE” in the center space of the “ARM”
5. Ensuring both are in the upright position.
6. Opening the stand so it is in the “WALL MOUNT” position
7. Aligning a coil pin in parallel with the hole on the left side of the “BASE” and pressing the coil pin in with a hand clamp
8. Repeating for the right side coil pin and hole
9. Setting the Stand in the “CLOSED” position
10. Positioning the square “TONGUE” hole over the square “CASE” hole ensuring both parts are in the upright position
11. Turning both parts over as one object
12. Pressing the “PIN” through the “TOUNGUE” until it snaps into the “CASE”

In a further beneficial aspect a device stand prepared according to principles of the invention will include certain detent features that significantly and surprisingly increase the usefulness of the device.

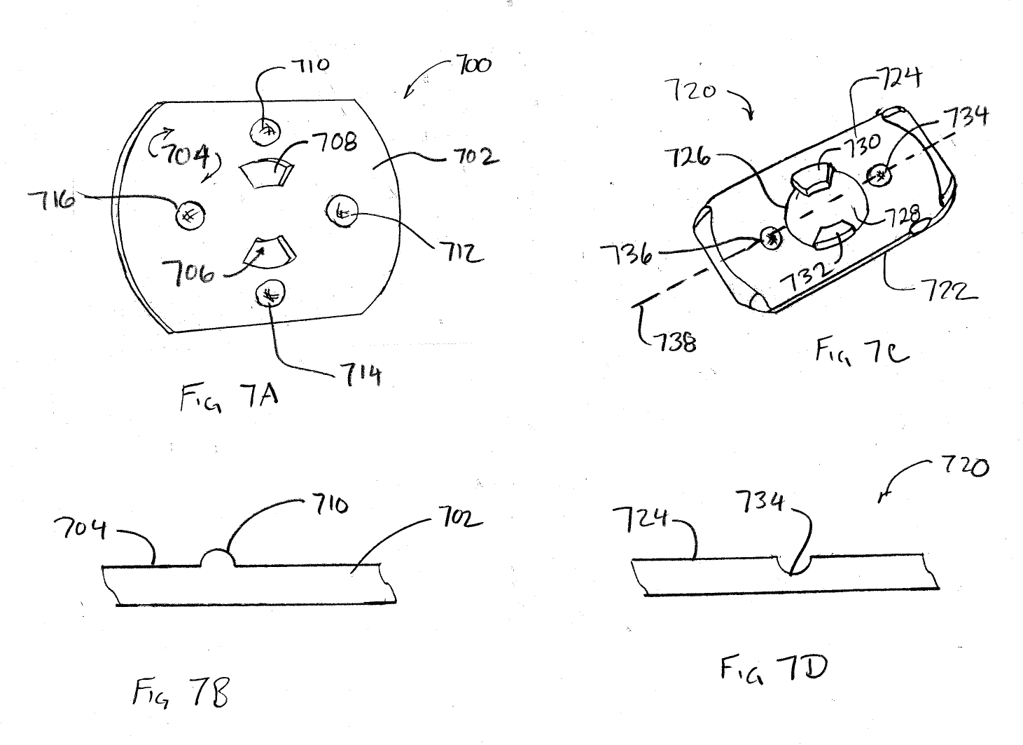

FIG. 7A shows, in schematic perspective view, a universal mount portion 700 of a supporting assembly for a device stand prepared according to principles of the invention. The universal mount includes a body member 702 with a first surface region 704. The body member 702 includes first 706 and second 708 apertures therethrough. In light of the foregoing description, one of skill in the art will understand that the apertures 706, 708 are configured and adapted to receive the corresponding barb portions of a pin element therethrough.

In the illustrated embodiment, the first surface region 704 includes first 710, second 712, third 714 and fourth 716 protrusions. In the illustrated embodiment, the protrusions are integrally formed with the body member 702.

FIG. 7B shows a portion of body member 702 in schematic cross-section view. As noted above, body member 702 includes a surface region 704 with a protrusion (e.g., 710). In the illustrated embodiment, the protrusion 710 has a generally hemispherical aspect and is integrally formed with the body member 702.

One of skill in the art will understand that these characteristics are merely exemplary, and that in other embodiments, alternative configurations will be employed. Thus, for example, the protrusion may be formed as a separate component coupled to the body member 702. Moreover, in certain embodiments of the invention, the protrusion will have, for example, an ellipsoidal configuration, pyramidal configuration, a truncated pyramidal configuration, a conical configuration, a truncated conical configuration, or any other configuration suitable to a particular application of the device stand.

FIG. 7C shows, in schematic perspective view, a portion of a tongue element 720 of a device stand prepared according to principles of the invention. The tongue element 720 includes a body member 722 with a first surface region 724 and an exemplary generally circular aperture 726 therethrough.

Disposed within aperture 726 is a pin element 728 including first 730 and second 732 barb portions. Aperture surface region 724 includes a first recess 734 and a second recess 736 disposed generally along a longitudinal axis 738 of the body member 722.

FIG. 7D shows a portion of tongue element 720 in schematic cross-section view. As noted above, tongue element 720 includes a surface region 724 with a recess (e.g., 734). In the illustrated embodiment, the recess 734 has a generally hemispherical aspect and is integrally formed within the tongue element 720. One of skill in the art will appreciate that the shape of the recess will be selected to accommodate a corresponding protrusion, e.g. 710, and may be of any configuration appropriate to this purpose. It will be apparent to one of skill in the art that, while FIGS. 7A-7D show protrusions on the universal mount portion and recesses on the tongue portion, the opposite arrangement will readily be used in alternative configurations and embodiments of the invention.

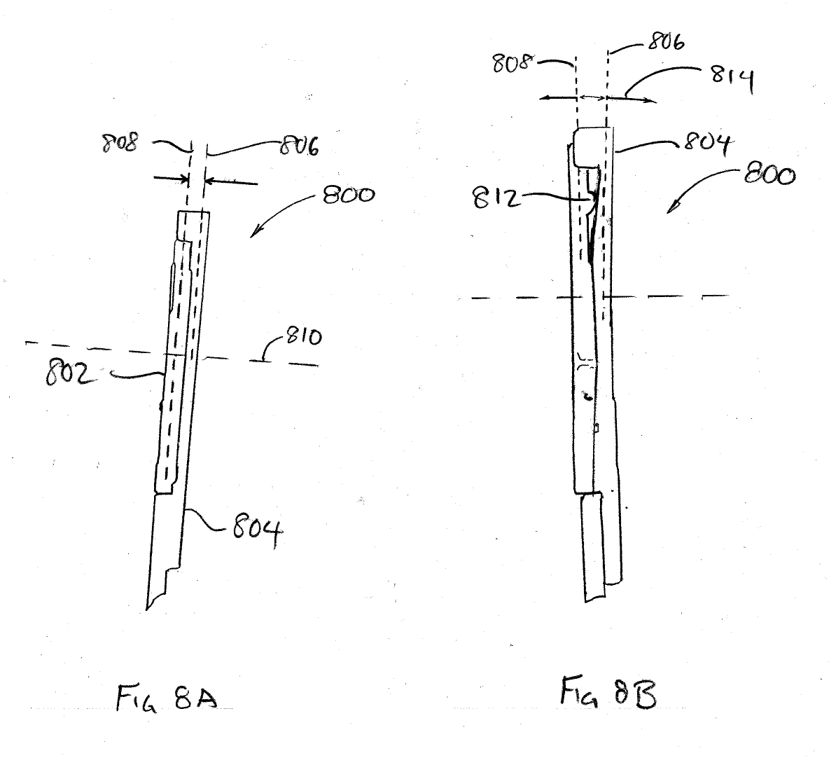

FIGS. 8A and 8B illustrate, in side view, operation of one exemplary embodiment of a device stand 800 prepared according to principles of the invention. In FIG. 8A the universal mount portion 802 is shown in a configuration where it is aligned with the tongue portion 804 such that the protrusions and recesses are aligned. Consequently, longitudinal axes 806, 808 of the universal mount portion and tongue portion respectively are disposed substantially parallel to one another.

Rotation of the universal mount portion 802 about a transverse axis 810 tends to urge the protrusion e.g., 812 out of its corresponding recess by a substantially elastic deflection 814 of the tongue portion 804. This deflection causes the longitudinal axes 806, 808 to diverge from one another as shown. Further rotation of the universal mount portion with respect to the tongue portion results in the protrusion 812 arriving at, and becoming aligned with, a further recess of the tongue portion. This allows the deflection 814 to relax and the elasticity of the tongue portion 804 tends to retain the protrusion and recess in this alignment. This in turn tends to temporarily and beneficially prevent further rotation of the universal mount portion 802 about axis 810.

As will be readily apparent to one of skill in the art, by judicious placement of protrusions and protrusions and recesses, a device supported by the device stand will be positioned and conveniently retained in a portrait configuration, a landscape configuration, or any other configuration considered to be desirable for a particular application.

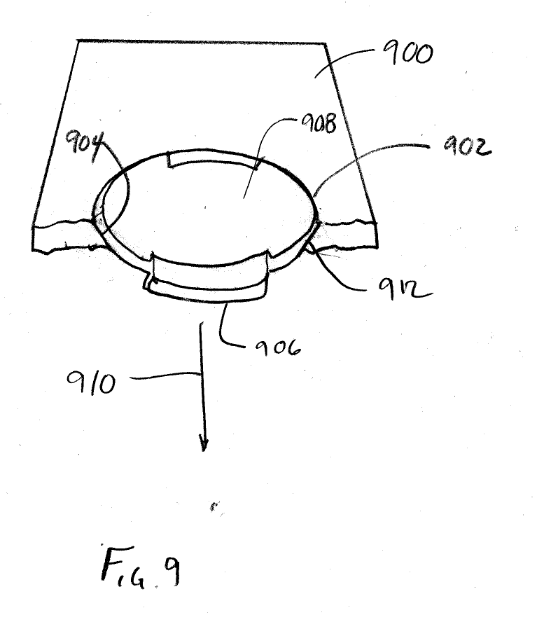

FIG. 9 shows, in cutaway perspective view, a portion of a tongue element 900 of a device stand prepared according to principles of the invention. The tongue element includes an aperture 902 having a tapered internal circumferential surface region 904. That is, the surface region 904 is configured as an internal frusto-conical surface. Consequently, to the extent that the barb elements 906 of the pin 908 exert an elastic force on a universal mount (not shown) the pin 908 is drawn inward 910, promoting a uniform frictional engagement between a frusto-conical external surface 912 of the pin 908 and the internal surface 904.

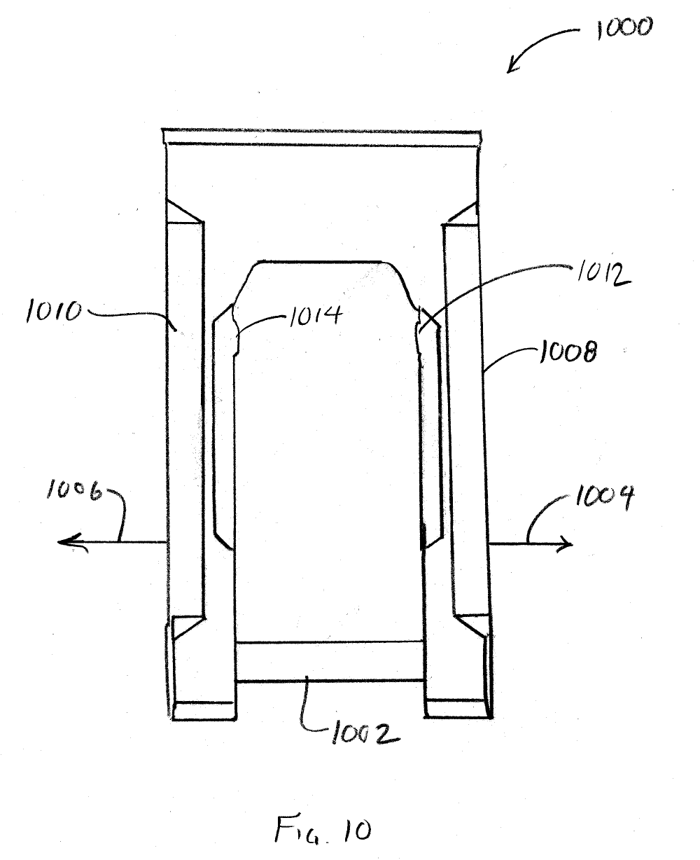

FIG. 10 shows, in schematic perspective view, a portion of an arm 1000 of a device stand prepared according to principles of the invention. The arm 1000 includes, for example, a reinforcing member 1002 which, when disposed in tension, prevents divergence 1004, 1006 of a first side 1008 from a second side 1010 of the arm 1000.

In a further aspect, the arm 1000 includes a first protrusion 1012 and a second protrusion 1014. Protrusions 1012 and 1014 serve as interference features, and interfere frictionally with the tongue (not shown) to hold the device stand in a collapsed configuration when desired.

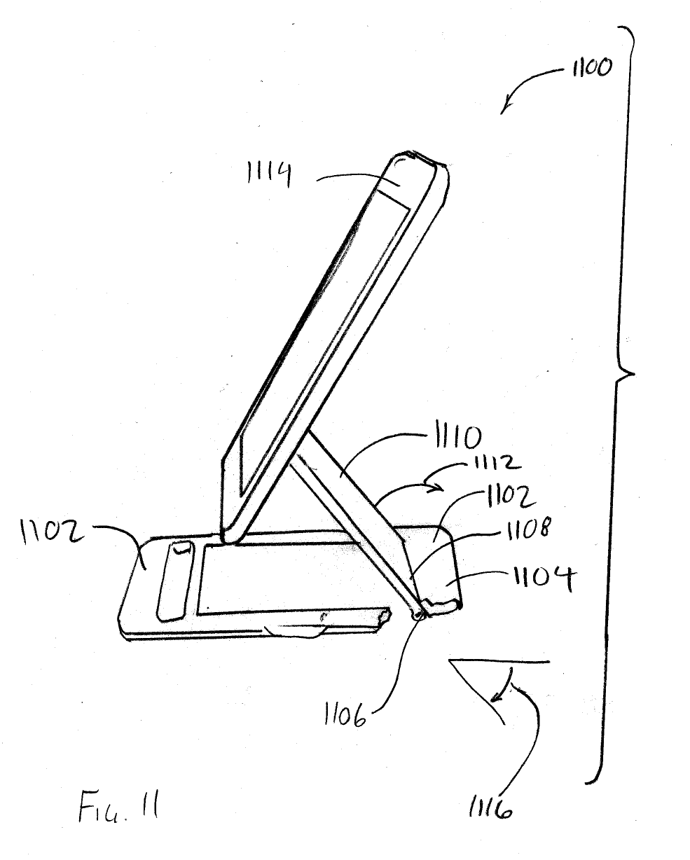

FIG. 11 shows, in cutaway perspective view, certain further aspects of an embodiment of a device stand 1100 prepared according to principles of the invention. The device stand 1100 includes a base portion 1102 with an upper surface region 1104 and an internal surface region 1106. The internal surface region 1106 is disposed at an oblique angle with respect to the upper surface region 1104. A further surface region 1108 of an arm element 1110 is arranged to mechanically interfere with surface region 1106 so as to limit a pivotal movement 1112 of the arm element 1110 with respect to the base portion 1102. In this way, a center of gravity of an electronic device 1114 is maintained above the base portion 1102, so as to prevent the device stand 1100 from tipping over.

In certain embodiments of the invention, the internal surface region 1106 is disposed at an angle 1116 of approximately 70° with respect to surface region 1104. In another embodiment, angle 1116 is selected to reside within a range from about 60° to about 80°. In still another embodiment of the invention, angle 1116 is selected to reside within a range from about 50° to about 90°. One of skill in the art will readily understand that any appropriate angle will be selected according to the requirements of a particular electronic device and device stand configuration to ensure basic stability of the device stand.

One of skill in the art will appreciate that, in light of the foregoing description, as well as the provisional applications herewith incorporated by reference, the described stand will be beneficially employed in many circumstances and in many corresponding embodiments. That is, one of skill in the art will appreciate that a stand according to principles of the invention will be advantageously employed in conjunction with, for example, a smart phone; any mobile device; a television screen; a laptop computer; a laptop-tablet hybrid; a tablet device; any type of single lens reflex and/or other type of camera and any other appropriate device, without limitation. It will also be appreciated that, while the device principally described here include the stand adapted to be coupled to a pre-existing device, certain inventive features of a stand according to principles of the invention will be advantageously employed in a unit that is integrated with the electronic device during its original design and manufacturing.

Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A stand for a portable information device comprising:
a base portion;
an arm portion;
a tongue portion; and
a universal coupling portion, wherein said universal coupling portion is coupled to said tongue portion by a pin having a barbed feature, and wherein said pin resides within an aperture of said arm portion, said aperture having a frusto-conical internal surface region.
